(19) United States
(12) Patent Application Publication
(10) Pub. No.: US 2001/0039877 A1
(43) Pub. Date: Nov. 15, 2001

(54) Electrostatic precipitator

(76) Inventor: Arthur G. Hein, North Vancouver (CA)

Correspondence Address: Mark Ming-Jen Yang, 800 - 885 West Georgia Street, Vancouver, British Columbia, V6C 3H1, CA

(21) Appl. No.: 09/779,539

(22) Filed: Feb. 9, 2001

Related U.S. Application Data
(60) Provisional application No. 60/183,494, filed on Feb. 11, 2000.

(51) Int. Cl. B03C 3/36; B03C 3/76

(52) U.S. Cl. 95/69; 96/32; 96/64

(57) ABSTRACT

An electrostatic precipitator for removing suspended particles from a gas stream that directs at least a portion of such gas stream upwardly at the precipitator inlet. This causes the gas flow near the bottom of the treatment zone in the precipitator to have a lower velocity. The gas flow near the bottom has a greater number of suspended particles as particles dislodged from the gas flow above may re-enter the gas flow at a point below. The slowed gas flow is in contact with the treatment zone for a longer period of time, thereby allowing for more particles to be dislodged.

### FIELD OF THE INVENTION

This invention relates generally to dry horizontal flow electrostatic precipitators and particularly to gas flow distribution at the inlet of such precipitators.

### DESCRIPTION OF PRIOR ART

The use of electrostatic precipitators to remove suspended particles (for example, dust) from gas streams is a well known art and dry horizontal flow precipitators are in service for many applications.

The treatment zone of a common dry horizontal flow precipitator consists of high voltage electrodes and collecting electrodes arranged to form gas passages parallel to the gas flow. The electrode systems are enclosed in a casing to contain the gas flow. Rapping systems are used to dislodge the dust from the electrodes, which then falls by gravity to the bottom of the precipitator. The bottom of the precipitator is equipped with a dust removal system to discharge the collected dust.

The gas is supplied to the precipitator through an inlet nozzle that connects the inlet duct to the precipitator casing inlet face and the gas flow is exhausted from the precipitator through an outlet duct that connects the precipitator casing outlet face to the exhaust duct.

Optimum performance has been associated with uniform gas flow through the treatment zone. Absolutely uniform flow is not achievable and the Institute of Clean Air Companies, an institute that includes major suppliers of electrostatic precipitators and was formed to encourage improvement of engineering and technical standards, updated and reissued their standard ICAC-EP-7 in January 1997 which specifies uniformity of gas flow within certain acceptable limits.

Precipitator inlet nozzles are usually equipped with gas distribution devices. These gas distribution devices are commonly turning vanes, straightening vanes, and diffuser screens. They are designed to provide uniform gas flow distribution across the inlet face of the precipitator if they conform to the ICAC-EP-7. Most precipitators in operation are designed to meet this accepted standard. U.S. Pat. No. 4,695,297 to Hein discloses a controlled, non-uniform gas flow distribution designed to improve precipitator efficiency. The flow distribution described in Hein does not conform to the accepted ICAC-EP-7 standard. This gas flow distribution is referred to as skewed gas flow distribution.

A problem with dry horizontal flow electrostatic precipitators is that of re-entrainment. Re-entrainment occurs when dust removed from the gas stream is dislodged by the rapper, but rather than fall to the bottom of the precipitator, re-enters the gas stream at a position below where it was dislodged. This causes the dust concentration, usually uniform when the gas enters the precipitator, to become greater near the bottom portion of the treatment zone closer to the outlet. A preferred gas flow distribution that improves precipitator collection efficiency is a gas flow distribution that decreases the flow velocity at the bottom of the treatment zone closer to the outlet, thereby increasing the time the gas with the higher concentration of dust is exposed to treatment.

In both the Hein device and the precipitators that meet the ICAC-EP-7 standard, the prior art utilizes gas flow distribution devices that are designed to introduce gas flow to the precipitator in a horizontal direction without a vertical component. What is needed, however, is a precipitator providing a higher velocity gas flow in the upper part of the treatment zone closer to the outlet, providing a means of lowering the effects of re-entrainment. This is because the resulting lower velocity gas flow in the lower part of the precipitator closer to the outlet increases the efficiency as described above. The gas flow profiles as disclosed in Hein deal with re-entrainment but result in high velocity flow continuing along the lower part of the treatment zone and in difficulty achieving the preferred outlet gas flow profile. The ICAC-EP-7 standard does not deal with the effects of re-entrainment.

Another attempt to solve the re-entrainment problem is disclosed in U.S. Pat. No. 3,733,785 to Gallaer. In the Gallaer precipitator the gas flow enters the precipitator without an upward component and is directed upwardly within the precipitator by a series of diverter units positioned within the precipitator. While this device provides a method of reducing re-entrainment it results in a more complex precipitator, requiring diverters in addition to materials found in an ordinary precipitator.

What is needed is a precipitator that is more effective than the prior art in providing an upward oriented gas flow to minimize the re-entrainment problem, while not requiring additional materials or units beyond those found in an ordinary precipitator.

### SUMMARY OF THE INVENTION

The present invention is a significant departure from accepted theory and practice in the way flow is supplied to the precipitator inlet face. Accepted theory and practice is to supply horizontal flow. The present invention introduces a vertical flow component at the precipitator inlet.

The gas flow distribution devices at or near the precipitator inlet face would be designed to supply the flow to the precipitator with an upward vertical component.

The present invention, by introducing the gas flow into the precipitator at an upward incline provides a precipitator of greater efficiency than available in the prior art.

### BRIEF DESCRIPTION OF THE DRAWINGS

Advantages of the present invention will become apparent from the following detailed description taken in conjunction with preferred embodiments shown in the accompanying drawings, in which:

FIG. 1 is a side view cross section of a dry horizontal gas flow precipitator according to the prior art;

FIG. 2 is a side view cross section of a precipitator according to the prior art designed for uniform gas flow as recommended by standard ICAC-EP-7;

FIG. 3 is a side view cross section of a precipitator according to the prior art designed for skewed gas flow distribution;

FIG. 4 is a side view cross section of a precipitator according to the present invention in which gas flow distribution devices are designed to provide a uniform horizontal flow with an upward component;

FIG. 5 is a side view cross section of a precipitator according to the present invention in which gas flow distribution devices are designed to provide an upward vertically skewed gas flow;

FIG. 6 shows the upwardly inclined flow therein with its horizontal and vertical components;

FIG. 7 is a side view cross-section of an inlet nozzle using two diffuser screens with an opening at the lower end of the upstream screen as a method of achieving an upward component of flow into the precipitator; and

FIG. 8 is a side view cross-section of an alternative embodiment thereof illustrating an inlet nozzle using two diffuser screens with a section at the lower end of the upstream screen having a lower porosity than the section immediately above it as a method of achieving an upward component of flow into the precipitator.

### DESCRIPTION OF THE PREFERRED EMBODIMENTS

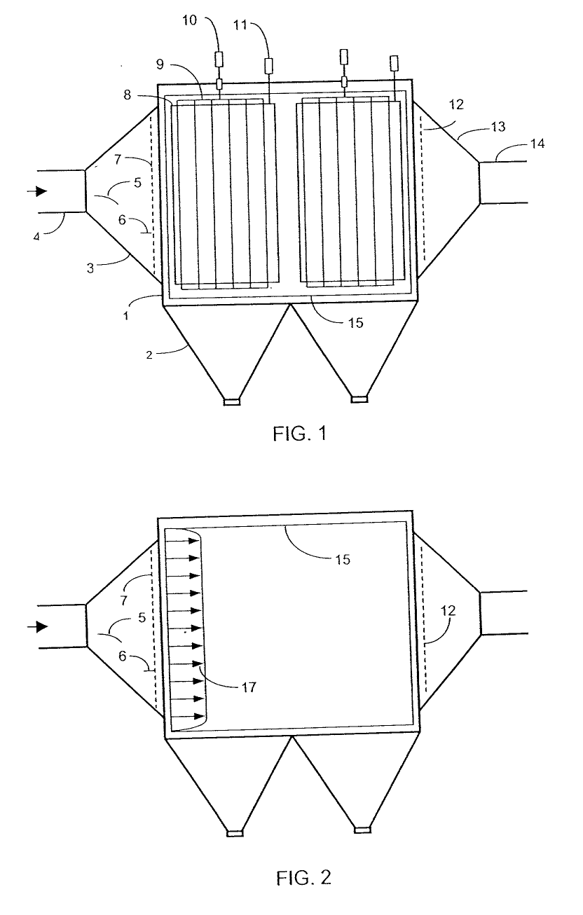

As best seen in FIG. 1, the components of a dry horizontal flow precipitator as seen in the prior art include casing 1, which encloses the electrode systems. Collecting electrodes 8 are spaced to form gas passages parallel to the gas flow. High voltage electrodes 9 are spaced in the gas passages between collecting electrodes 8 and are supported from insulators (not shown). The zone formed by the gas passages in which the flow is exposed to the influence of high voltage electrodes 9 and collecting electrodes 8 is called treatment zone 15. Treatment zone 15, as seen in FIG. 1 consists of two fields in the direction of gas flow. The number of fields in a precipitator may vary from as little as a single field to a larger number. The bottom of casing 1 is equipped with a dust removal system, which may be a hopper system 2 as shown in FIG. 1 or another system such as a drag conveyor or wet sluicing. Collected dust is dislodged from the electrodes 8, 9 by high voltage system rappers 10 and collecting system rappers 11, which may be positioned externally to the casing as seen in FIG. 1, or alternatively, rappers 10, 11 may be positioned within the casing.

Gas is introduced to the precipitator through inlet ducting 4, to inlet nozzle 3. The desired gas distribution across the precipitator inlet face is accomplished with turning vanes 5, straightening vanes 6, and diffuser screens 7 that are positioned in the inlet nozzle and at the precipitator inlet face. Gas is exhausted from the precipitator through an outlet diffuser screen 12 to an outlet nozzle 13 and an outlet duct 14. These systems are all conventional.

FIG. 2 illustrates the gas velocity profile of a prior art precipitator meeting the ICAC-EP-7 standard. The flow control devices, turning vanes 5, straightening vanes 6, and diffuser screens 7 are designed to supply a uniform horizontal flow into treatment zone 15. Arrows 17 indicate the vectors of the flow at the precipitator inlet face. Arrows 17 in FIG. 2 are of equal length and are completely horizontal with no vertical component. Outlet diffuser screen 12 is also designed for uniform flow resulting in uniform horizontal flow throughout the treatment zone 15.

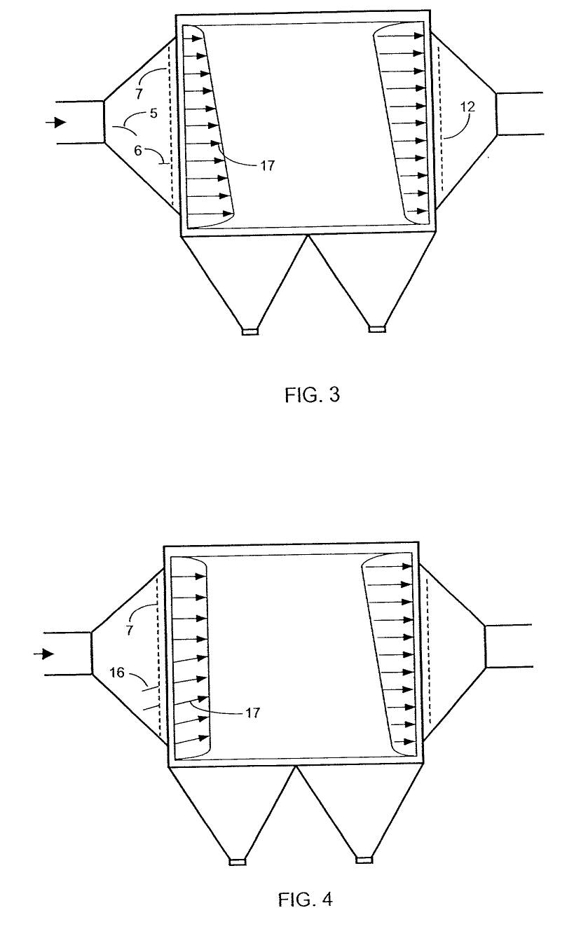

FIG. 3 illustrates the gas velocity profiles in a precipitator disclosed in U.S. Pat. No. 4,695,297 to Hein. The inlet flow control devices, turning vanes 5, straightening vanes 6, and diffuser screens 7 are designed to supply a horizontal flow into treatment zone 15. Arrows 17 indicate the vectors of flow at the precipitator inlet face and in this prior art precipitator arrows 17 are of unequal length, but are horizontal and have no vertical component. The skewed outlet flow profile is produced by the design of outlet diffuser screen 12.

In a preferred embodiment of the invention as best seen in FIG. 4, the horizontal component of the precipitator inlet flow distribution is designed to meet the ICAC-EP-7 standard. A diffuser screen 7 and one or more turning vanes 16 are designed to supply an upwardly inclined flow into the precipitator treatment zone 15. Arrows 17 indicate the vectors of flow at the precipitator inlet face. The horizontal component of the flow is equal for all of arrows 17 but at least some of arrows 17 are upwardly inclined as a vertical component of flow is provided. The gas flow profiles of precipitators according to the invention provide for the desired lower flow velocity near the bottom portion of the precipitator closer to the outlet by introducing a horizontal component to the flow at the precipitator inlet.

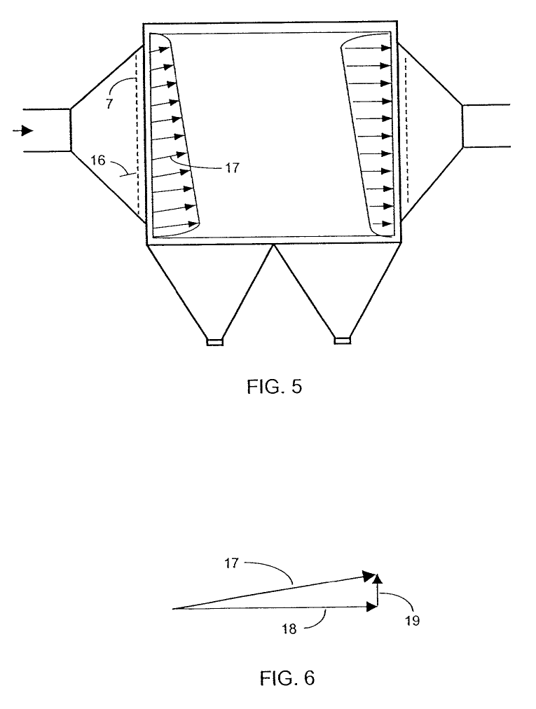

In an alternative embodiment of the invention as best seen in FIG. 5 the horizontal gas velocity profile is modeled on that described in U.S. Pat. No. 4,695,297 to Hein. The gas flow control devices, diffuser screen 7 and turning vane 16, are designed to provide an upwardly inclined flow into precipitator treatment zone 15. Arrows 17 indicate the vector of flow at the precipitator inlet face. The horizontal component of the flow is not equal for each arrow 17. Some or all of arrows 17 are upwardly inclined as a vertical component of flow is provided.

FIG. 6 illustrates a typical upwardly inclined gas flow arrow 17 having both a horizontal flow component 18 and a vertical flow component 19 produced by the gas flow control devices, diffuser screen 7, and turning vane 16.

The invention requires flow control means to provide upwardly inclined flow at the inlet face of a horizontal flow precipitator. These flow control means are of a conventional variety, and many methods of creating the upward flow are possible. In one embodiment of the invention, conventional single or multiple turning vanes 16 could be used as best seen in FIG. 4 and FIG. 5.

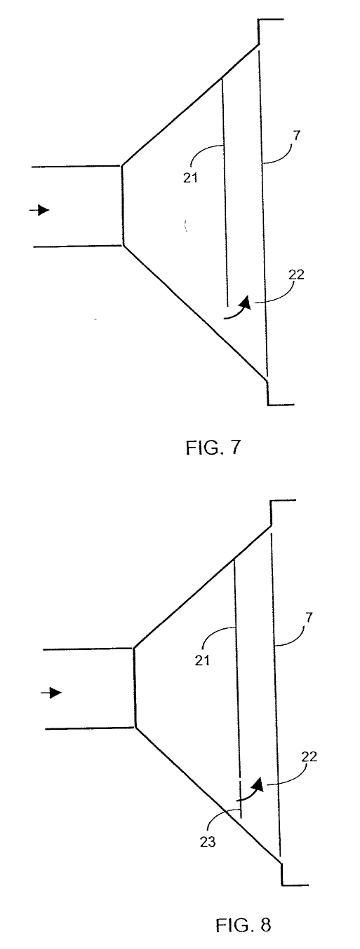

In an alternative embodiment, as best seen in FIG. 7, the flow control means provides a greater flow for the lower part of the precipitator treatment zone 15 by using an open section at the lower end of diffuser screen 21 positioned upstream of diffuser screen 7 at the precipitator inlet face. The diffuser screen 7 is designed to permit only the desired flow into the lower part of the treatment zone 15, which results in a portion of the flow directed upwardly as shown by arrow 22.

In another alternative embodiment shown in FIG. 8, a section or sections of low porosity diffuser screen 23 would be positioned under diffuser screen 21 in place of the open section shown in FIG. 7. This enables additional control in achieving the desired gas flow distribution.

It is common practice to have more than one diffuser screen 7 in a series as the gas flow approaches the precipitator treatment zone. Diffuser screen 21 could therefore be a single screen in a series, a modified existing screen or a replacement screen for a prior art precipitator. It is also common to have a space below the lower end of diffuser screen 21 to prevent dust accumulation, however, in the prior art this space is kept at a minimum and is not used for controlling gas flow.

The embodiments of the invention described above are intended to be merely exemplary and those skilled in the art will be able to make numerous variations and modifications, in addition to those described above, without departing from the spirit or scope of the invention. All such variations and modifications are intended to be included within the scope of the invention, as defined in the following claims:

I claim:

1. In a dry horizontal flow electrostatic precipitator for removing suspended particles from a gas stream, the precipitator having a casing, a treatment zone comprising collecting and high voltage electrodes, rapping means to dislodge the collected dust, an inlet opening at one end of the treatment zone for admitting the untreated gas stream and an outlet opening at the other end of the treatment zone for discharging the treated gas stream, the improvement comprising gas flow control means at or near the inlet opening to supply upwardly inclined flow with a uniform horizontal component of flow to the treatment zone.

2. The precipitator of claim 1, further comprising gas flow control means at or near the inlet opening to supply upwardly inclined flow with a skewed gas flow distribution.

3. The precipitator of claim 1 wherein a portion or all of the gas stream entering the treatment zone is given an upward component of flow by
(a) a first diffuser screen, and;
(b) a second diffuser screen upstream to said first diffuser screen, the second diffuser screen having an opening at the lower portion thereof.

4. The precipitator of claim 1 wherein a portion or all of the gas stream entering the treatment zone is given an upward component of flow by
(a) a first diffuser screen, and;
(b) a second diffuser screen upstream to said first diffuser screen, the second diffuser screen having one or more sections of low porosity in the lower portion thereof.

5. The precipitator of claim 2 wherein a portion or all of the gas stream entering the treatment zone is given an upward component of flow by
(a) a first diffuser screen, and;
(b) a second diffuser screen upstream to said first diffuser screen, the second diffuser screen having an opening at the lower portion thereof.

6. The precipitator of claim 2 wherein a portion or all of the gas flow entering the treatment zone is given an upward component of flow by
(a) a first diffuser screen, and;
(b) a second diffuser screen upstream to said first diffuser screen, the second diffuser screen having one or more sections of low porosity in the lower portion thereof.

7. An electrostatic precipitator for removing suspended particles from a gas stream, comprising:
(a) a casing;
(b) an inlet to said casing;
(c) an outlet from said casing;
(d) a treatment zone within said casing;
wherein said inlet comprises means for directing at least a portion of said gas stream upwardly.

8. The electrostatic precipitator of claim 7, wherein said means for directing directs all of said gas flow upwardly.

9. The electrostatic precipitator of claim 8, wherein said means for directing directs said gas entering a higher portion of said treatment zone at a lower velocity than said gas entering a lower portion of said treatment zone.

10. The electrostatic precipitator of claim 7, wherein said means for directing comprises:
(a) a first diffuser screen, and;
(b) a second diffuser screen upstream to said first diffuser screen, the second diffuser screen having one or more sections of low porosity in the lower portion thereof.

11. The electrostatic precipitator of claim 10 further comprising:
(e) dust removal means within said casing.

12. The electrostatic precipitator of claim 11, wherein said treatment zone comprises high voltage electrodes and collecting electrodes.

13. The electrostatic precipitator of claim 12, wherein said dust removal means comprises a hopper system.

14. The electrostatic precipitator of claim 7 wherein said means for directing comprises:
(i) a first diffuser screen, and;
(ii) a second diffuser screen upstream to said first diffuser screen, the second diffuser screen having an opening at the lower portion thereof.

15. The electrostatic precipitator of claim 7 wherein said gas flow enters the treatment zone at an approximately uniform velocity.

16. The electrostatic precipitator of claim 15 further comprising:
(e) dust removal means within said casing.

17. The electrostatic precipitator of claim 16, wherein said treatment zone comprises high voltage electrodes and collecting electrodes.

18. The electrostatic precipitator of claim 17, wherein said dust removal means comprises a hopper system.

19. The electrostatic precipitator of claim 15 wherein said means for directing comprises:
(i) a first diffuser screen, and;
(ii) a second diffuser screen upstream to said first diffuser screen, the second diffuser screen having an opening at the lower portion thereof.

20. The electrostatic precipitator of claim 15, wherein said means for directing comprises:
(a) a first diffuser screen, and;
(b) a second diffuser screen upstream to said first diffuser screen, the second diffuser screen having one or more sections of low porosity in the lower portion thereof.

21. A method of removing suspended particles from a gas stream comprising the following steps:
(a) directing said gas flow into a casing, at least a portion of said gas flow being directed upwardly into said casing;
(b) treating said gas flow to remove the suspended particles;
(c) passing said gas stream out of said casing.
